(19) United States
(12) Patent Application Publication
(10) Pub. No.: US 2005/0071881 A1
(43) Pub. Date: Mar. 31, 2005

(54) Systems and methods for playlist creation and playback

(76) Inventor: Sachin G. Deshpande, Vancouver, WA (US)

Correspondence Address: Wesley, L. Austin;Madson & Metcalf, Suite 900, 15 West South Temple, Salt Lake City, UT, 84101, US

(21) Appl. No.: 10/675,887

(22) Filed: Sep. 30, 2003

(51) Int. Cl. H04N 7/173; G06F 13/00; H04N 5/445; H04N 7/16

(52) U.S. Cl. 725/88; 725/102; 725/135; 725/89; 725/125

(57) ABSTRACT

Systems and methods for playlist creation and playback are disclosed. An exemplary method involves receiving a video. The video is played on a display device. A user's designation of a video segment from the video is received. The video segment is added to a playlist. Adding the video segment to the playlist may involve generating display instructions for displaying the video segment and adding the display instructions to the playlist. The video segment may be played back on the display device in response to a user request.

### TECHNICAL FIELD

The present invention relates generally to digital media technology. More specifically, the present invention relates to playlists for streaming media.

### BACKGROUND

Many types of media, such as movies, music, television programs, electronic books, and so forth, are now available in a digital format. Consumers who wish to view, listen to, read, or otherwise make use of digital media may purchase or rent physical copies of the media. For example, compact discs (CDs) and digital versatile discs (DVDs) are now ubiquitous in the industry. Alternatively, consumers may purchase the right to have the media broadcast to them. For example, consumers may subscribe to broadcast services such as digital cable, direct broadcast satellite (DBS), video-on-demand (VoD), or the like. Sometimes consumers are permitted to record digital media content that is broadcast to them. Personal video recorders (PVRs), which digitally record broadcast television programs, are now replacing analog video cassette recorders (VCRs) in many households. In addition, a user may have his/her home videos stored in a digital form on a server, recorder, storage device, or the like in the home.

Another way in which digital media may be distributed to a consumer is commonly referred to as “streaming.” Digital media files may be transmitted from a server to a client over a one or more computer networks. When a client requests a digital media file from a server, the client typically provides the server with the address of the media file, such as the Universal Resource Locator (URL) of the media file. The server then accesses the media file and sends it to the client as a continuous data stream. Streaming media is often sent in compressed form over the network, and is generally played by the client as it arrives. With streaming media, client users typically do not have to wait to download a large media file before seeing and/or hearing the media file. Instead, the media file is sent in a continuous stream and is played as it arrives.

A media playlist typically includes information about a number of individual media files. A playlist may contain information such as which pieces of content to play, the order in which to play referenced content, whether to play certain pieces of content more than one time, etc. Playlists typically do not contain the actual media data, but rather references to the media data. As a result, playlist files are typically small, generally only containing text, and are generally easy and computationally inexpensive to modify. References to a single piece of media may appear in many playlist files. Playlists may be implemented either on a client or on a server. Playlists may be stored on a client or on a server.

In view of the above, benefits may be realized by improvements relating to the creation and playback of playlists for streaming media, such as streaming video. The term streaming video is used to refer to a media which may include both streaming audio and streaming video data. Although embodiments disclosed herein will be explained for a streaming video, the proposed approach is also applicable to broadcast services such as digital cable, DBS, VoD and PVRs.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating an exemplary operating environment in which some embodiments may be practiced;

FIG. 2 is a functional block diagram illustrating an embodiment of the client;

FIG. 3 is a functional block diagram illustrating an embodiment of a segment designation component;

FIG. 4 is a functional block diagram illustrating an alternative embodiment of a segment designation component;

FIG. 5 illustrates a video and a navigation video strip being displayed on the display screen of the display device;

FIG. 6 illustrates an exemplary way in which a beginning detection component may determine a starting frame for a segment of interest;

FIG. 7 is a block diagram illustrating an embodiment of display instructions that may be generated by the playlist organization component;

FIG. 8 is a block diagram illustrating an embodiment of a playlist;

FIG. 9 is a flow diagram illustrating an exemplary way in which the playlist display component may play back the video segments in the playlist of FIG. 8;

FIG. 10 is a block diagram illustrating an alternative embodiment of a playlist;

FIG. 11 is a flow diagram illustrating an exemplary way in which the playlist display component may play back the video segments in the playlist of FIG. 10;

FIG. 12 is a block diagram illustrating an embodiment of the prefetch instructions for a particular video segment;

FIG. 13 is a flow diagram illustrating an embodiment of a method that may be performed by the client in the operating environment shown in FIG. 1; and

FIG. 14 is a block diagram illustrating the components typically utilized in a client and/or a server used with embodiments herein.

### DETAILED DESCRIPTION

A method for providing playlist functionality is disclosed. The method may be implemented in a client. The method involves receiving a video. The video is displayed on a display device. A user designation of a video segment from the video is received. The video segment is added to a playlist. Adding the video segment to the playlist may involve generating display instructions for displaying the video segment. The display instructions may be added to the playlist. The method may additionally involve receiving user input to determine whether the video segment is added to a new playlist or to an existing playlist.

In some embodiments, the video may be streamed from a server. Alternatively, the video may be stored on the client. Alternatively still, the video may be available remotely via file sharing. In some embodiments, the playlist may be stored on the client. Alternatively, the playlist may be stored on the server. The playlist may be created using Synchronized Multimedia Integration Language (SMIL).

Receiving the user designation of the video segment may involve receiving a first user indication of a beginning portion of the video segment. The first user indication may be received when the beginning portion is played on the display device. A second user indication of an ending portion of the video segment may also be received. The second user indication may be received when the ending portion is played on the display device.

Alternatively, receiving the user designation of the video segment may involve receiving a first user indication of a beginning portion of the video segment. The first user indication may be received after the beginning portion is played on the display device. Receiving the user designation of the video segment may additionally involve receiving a second user indication of an ending portion of the video segment. In some embodiments, receiving the first user indication may involve displaying a navigation video strip on the display device. The navigation video strip may include a plurality of frames from the video. A user selection of a frame from the plurality of frames may be received. The frame may substantially correspond to the beginning portion of the video segment. Receiving the first user indication may additionally involve supporting user interaction with the navigation video strip.

The video segment may be played in response to a user request. The video segment may be played using Real Time Streaming Protocol (RTSP). In some embodiments, playing the video segment involves retrieving at least a portion of the video segment in parallel with playing a previous video segment in the playlist. The amount of the video segment to be retrieved in parallel may be determined by the client while creating the playlist. Alternatively, the amount of the video segment to be retrieved in parallel may be determined by the client after requesting information from the server and while creating the playlist. Alternatively still, information about the amount of the video segment to be retrieved in parallel may be stored in the playlist.

A client that is configured to provide playlist functionality is also disclosed. The client includes a stream reception component configured to receive a video. The client may also include a stream display component configured to play the video on a display device. In addition, the client may include a segment designation component configured to receive a user designation of a video segment from the video. A playlist management component may also be included in the client. The playlist management component may be configured to add the video segment to a playlist. The playlist management component may be further configured to receive user input to determine whether the video segment is added to a new playlist or to an existing playlist.

In some embodiments, the video may be streamed from a server. Alternatively, the video may be stored on the client. Alternatively still, the video may be available remotely via file sharing. In some embodiments, the playlist may be stored on the client. Alternatively, the playlist may be stored on the server. The playlist may be created using Synchronized Multimedia Integration Language (SMIL).

In some embodiments, the segment designation component may include a beginning detection component and an ending detection component. The beginning detection component may be configured to receive a first user indication of a beginning portion of the video segment. The first user indication may be received at substantially the same time as the beginning portion is played on the display device. The ending detection component may be configured to receive a second user indication of an ending portion of the video segment. The second user indication may be received at substantially the same time as the ending portion is played on the display device.

In alternative embodiments, the beginning detection component may be configured to receive a first user indication of a beginning portion of the video segment. The first user indication may be received after the beginning portion is played on the display device. The ending detection component may be configured to receive a second user indication of an ending portion of the video segment.

The client may also include a video strip display component that is configured to display a navigation video strip on the display device. The navigation video strip may include a plurality of frames from the video. In some embodiments, receiving the first user indication may involve receiving a user selection of a frame from the plurality of frames.

A set of executable instructions for implementing a method for providing playlist functionality is also disclosed. The method may involve receiving a video. The video may be played on a display device. A user designation of a video segment from the video may be received. The video segment may be added to a playlist. Adding the video segment to the playlist may involve generating display instructions for displaying the video segment, and adding the display instructions to the playlist. The method may additionally involve receiving user input to determine whether the video segment is added to a new playlist or to an existing playlist.

In some embodiments, the video may be streamed from a server. Alternatively, the video may be stored on the client. Alternatively still, the video may be available remotely via file sharing. In some embodiments, the playlist may be stored on the client. Alternatively, the playlist may be stored on the server. The playlist may be created using Synchronized Multimedia Integration Language (SMIL).

Receiving the user designation of the video segment may involve receiving a first user indication of a beginning portion of the video segment. The first user indication may be received at substantially the same time as the beginning portion is played on the display device. A second user indication of an ending portion of the video segment may also be received. The second user indication may be received at substantially the same time as the ending portion is played on the display device.

Alternatively, receiving the user designation of the video segment may involve receiving a first user indication of a beginning portion of the video segment. The first user indication may be received after the beginning portion is played on the display device. Receiving the user designation of the video segment may additionally involve receiving a second user indication of an ending portion of the video segment.

The method may additionally involve playing the video segment in response to a user request. The video segment may be played using Real Time Streaming Protocol (RTSP). In some embodiments, playing the video segment involves retrieving at least a portion of the video segment in parallel with playing a previous video segment in the playlist.

A set of executable instructions for implementing a method for providing playlist functionality is also disclosed. The method involves receiving a user designation of a video segment from a video. Display instructions for displaying the video segment are generated. The display instructions are added to a playlist. The method may additionally involve receiving user input to determine whether the video segment is added to a new playlist or to an existing playlist.

In some embodiments, the video may be streamed from a server. Alternatively, the video may be stored on the client. Alternatively still, the video may be available remotely via file sharing. In some embodiments, the playlist may be stored on the client. Alternatively, the playlist may be stored on the server. The playlist may be created using Synchronized Multimedia Integration Language (SMIL).

A set of executable instructions for implementing a method for providing playlist functionality is also disclosed. The method may involve receiving a user designation of a media segment from a media file. Instructions may be generated for producing a user-perceptible form of the media segment. The instructions may be added to a playlist. The method may additionally involve receiving user input to determine whether the video segment is added to a new playlist or to an existing playlist.

In some embodiments, the video may be streamed from a server. Alternatively, the video may be stored on the client. Alternatively still, the video may be available remotely via file sharing. In some embodiments, the playlist may be stored on the client. Alternatively, the playlist may be stored on the server. The playlist may be created using Synchronized Multimedia Integration Language (SMIL).

Various embodiments of the invention are now described with reference to the Figures, where like reference numbers indicate identical or functionally similar elements. It will be readily understood that the components of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Those skilled in the art will appreciate that many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, those skilled in the art will recognize that such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

The order of the steps or actions of the methods described in connection with the embodiments disclosed herein may be changed by those skilled in the art without departing from the scope of the present invention. Thus, any order in the Figures or detailed description is for illustrative purposes only and is not meant to imply a required order.

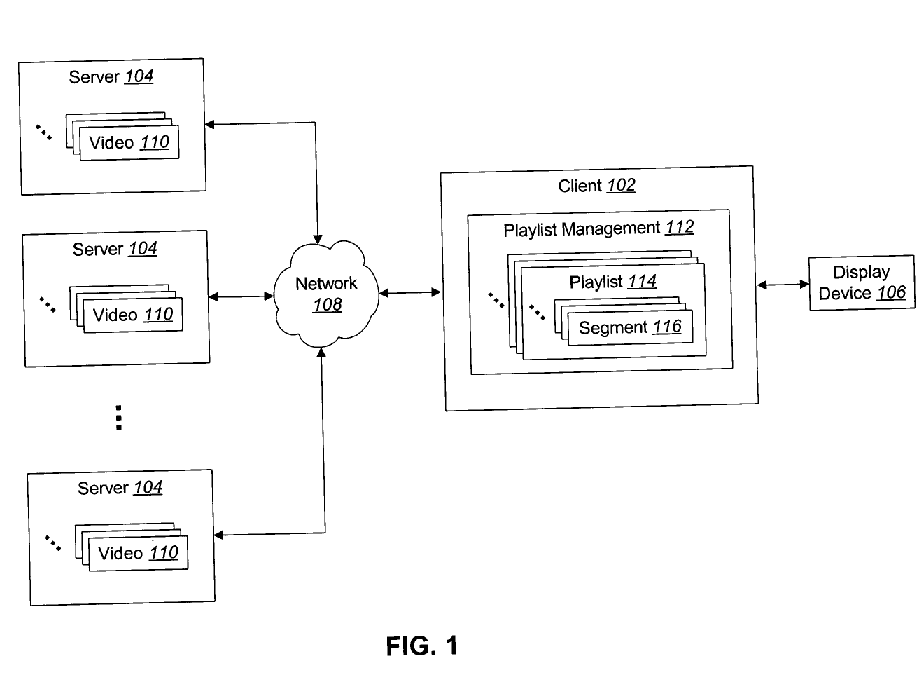

FIG. 1 is a block diagram illustrating an exemplary operating environment in which some embodiments may be practiced. As shown, embodiments disclosed herein may involve interaction between a client 102 and one or more servers 104. Examples of clients 102 that may be used with embodiments disclosed herein include a computer, a television with data processing capability, television in electronic communication with a set-top box, a handheld computing device, etc. The client 102 typically includes or is in electronic communication with a display device 106.

Data that is transmitted from the client 102 to one of the servers 104 (and vice versa) may pass through one or more intermediate nodes on one or more computer networks 108 en route to its destination. Embodiments may be used in personal area networks (PANs), local area networks (LANs), storage area networks (SANs), metropolitan area networks (MANs), wide area networks (WANs), and combinations thereof (e.g., the home network, the Internet) with no requirement that the client 102 and server 104 reside in the same physical location, the same network 108 segment, or even in the same network 108. A variety of different network configurations and protocols may be used, including Ethernet, TCP/IP, UDP/IP, IEEE 802.11, IEEE 802.16, Bluetooth, asynchronous transfer mode (ATM), fiber distributed data interface (FDDI), token ring, and so forth, including combinations thereof.

The servers 104 are configured to deliver streaming media to the client 102. Embodiments disclosed herein will be described in connection with streaming video. However, those skilled in the art will recognize that the inventive principles disclosed herein may also be utilized in connection with other forms of streaming media, such as music, electronic books, etc., or a combination of such media, such as video with synchronized audio, etc.

When a server 104 is streaming a video 110 to a client 102, the client 102 processes the video 110 as it is received from the server 104 and plays the video 110 on the display device 106. The client 102 typically discards the video 110 without storing it, although in some embodiments the client 102 may store the video 110 (or portions thereof). The streaming of video 110 from the server 104 to the client 102 may occur in accordance with a variety of different protocols, such as the Real Time Streaming Protocol (RTSP).

The client 102 includes a playlist management component 112. The playlist management component 112 allows a user to create a video playlist 114 consisting of segments 116 of one or more videos 110 that are of interest to the user. The playlist management component 112 also allows a user to play back the video segments 116 in the playlist 114. Each playlist 114 may include segments 116 from different videos 110, which may be stored on different servers 104. As shown in FIG. 1, the playlist(s) 114 may be stored on the client 102. Alternatively, or in addition, the playlist(s) 114 may be stored on one or more servers 104. Alternatively, in some embodiments, the playlist management 112 component may reside on a server 104 instead of the client 102. Alternatively still, the playlist management component 112 may reside on both the server 104 and the client 102.

As used herein, a “video segment” 116 or “segment of interest” 116 from a video 110 may refer to a portion of the video 110. For example, if the duration of a video 110 is 60 minutes, a segment of interest 116 from the video 110 may be the portion of the video 110 between 10 minutes and 20 minutes (measured relative to the start of the video 110).

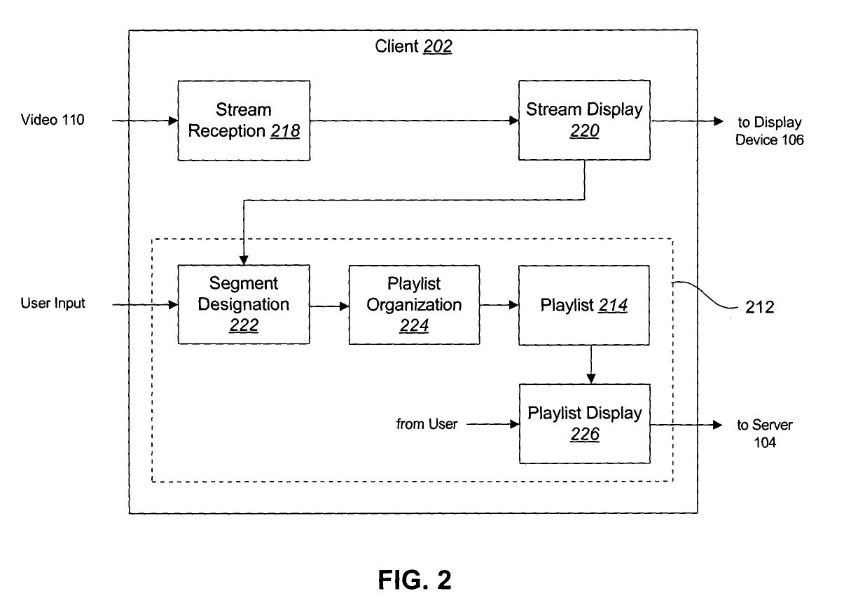

FIG. 2 is a functional block diagram illustrating an embodiment of the client 202. The client 202 includes a stream reception component 218 and a stream display component 220. The stream reception component 218 receives the video 110 as it is being streamed from the server 104. The stream reception component 218 provides the video 110 to a stream display component 220, which decodes and plays the video 110 on the display device 106.

As discussed previously, the client 202 includes a playlist management component 212. The embodiment of the playlist management component 212 shown in FIG. 2 includes a segment designation component 222. The segment designation component 222 enables a user to designate video segments 116 in the video 110 that are to be added to a playlist 214. Various embodiments of the segment designation component 222 will be described below.

The playlist management component 212 also includes a playlist organization component 224. The playlist organization component 224 adds the video segments 116 that have been designated by the user to the appropriate playlist 214. A particular video segment 116 designated by the user may be added to an existing playlist 214. Alternatively, a new playlist 214 may be created, and the video segment 116 may be added to the new playlist 114. The user may be permitted to choose between adding the video segment 116 to an existing playlist 214 or creating a new playlist 214. Typically, adding a video segment 116 to a playlist 214 involves generating instructions for displaying the video segment 116, and adding the display instructions to the playlist 214.

The playlist management component 212 also includes a playlist display component 226. From time to time, a user may desire to play a particular playlist 214. In response to a user request to play a playlist 214, the playlist display component 226 plays the video segments 116 in the requested playlist 214.

Playback of a video segment 116 from a playlist 214 may involve retrieving the video segment 116 from a server 104. Thus, during playback of a playlist 214, the playlist display component 226 may send one or more requests to one or more servers 104 to retrieve the video segments 116 in the playlist 214. In embodiments where a playlist 214 is stored on the server 104, the playlist 214 may be retrieved partially or completely from the server 104 as the first step by the playlist display component 226. In some embodiments, the video segments 116 may be streamed from a server 104 to the stream reception component 218 in the client 202. Alternatively, the playlist display component 226 may retrieve the video segments 116 from the servers 104 using a file sharing protocol (e.g., Network File System (NFS), Server Message Block (SMB), Common Internet File System (CIFS), etc.) and then play the video segments 116 on the display device 106. Alternatively still, the video segments 116 may be downloaded to and stored locally on the client 202 during creation of the playlist 214. Then, during playback of the playlist 214, the playback display component 226 may retrieve the video segments 116 in the playlist 214 from a local storage device and play them on the display device 106. This may typically be done using a digital rights management (DRM) component. In some embodiments, one or more of the components 222, 224, 214 may also or may only reside on the server 104 instead of the client 102.

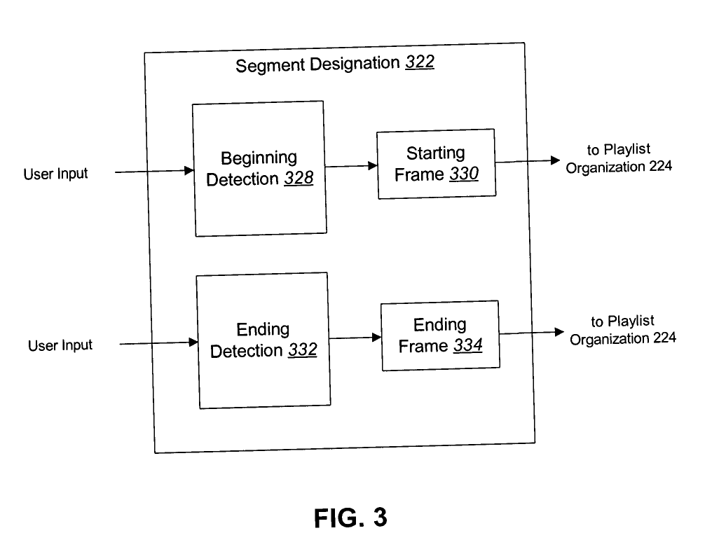

FIG. 3 is a functional block diagram illustrating an embodiment of a segment designation component 322. The segment designation component 322 shown in FIG. 3 is configured so that a user can add a segment of interest 116 to a playlist 114 while the segment of interest 116 is being viewed or displayed. For example, a user who has previously seen a particular video 110 may know that he wants to add a favorite scene from the video 110 to the playlist 114 before that part of the video 110 is played.

During playback of a video 110, just before the segment of interest, the user inputs an indication that the beginning of the segment of interest 116 has been reached. For example, the user might press a button on a remote control or keyboard, click a mouse button, etc. This user input is provided to a beginning detection component 328, which determines a starting frame 330 for the segment of interest. Various exemplary methods for determining the starting frame 330 will be discussed below.

When the segment of interest ends, the user inputs an indication that the end of the segment of interest 116 has been reached. This user input is provided to an ending detection component 332, which determines an ending frame 334 for the segment of interest 116. The ending frame 334 of the segment of interest 116 is typically the current frame (i.e., the frame displayed on the display device 106) when the second user indication is received. The starting frame 330 and the ending frame 334 for the segment of interest 116 are provided to the playlist organization component 224. The segment designation component 322 may reside on the client 102, the server 104, or both. If the segment designation component 322 resides on the server 104, the user input from the client 102 may be transmitted on the network 108 to the server 104.

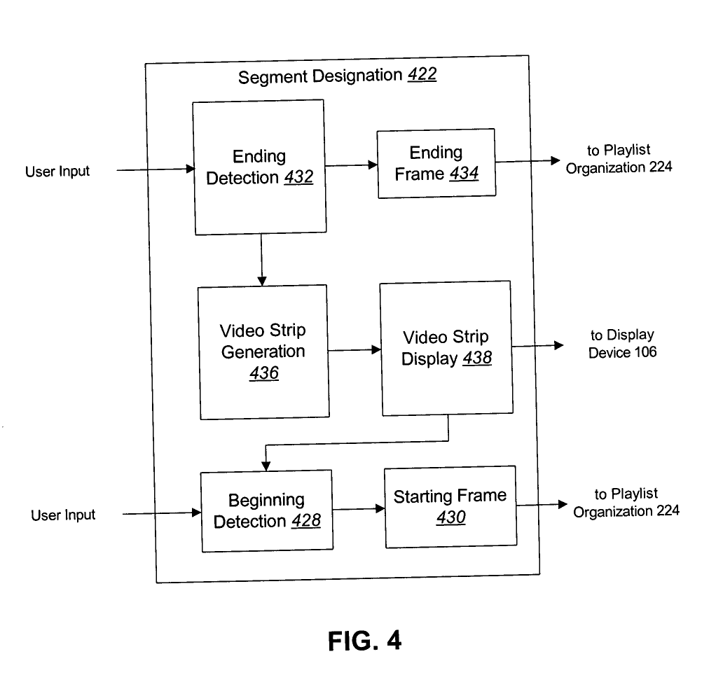

FIG. 4 is a functional block diagram illustrating an alternative embodiment of a segment designation component 422. The segment designation component 422 shown in FIG. 4 is configured so that a user can add a segment of interest 116 to a playlist 114 after the segment of interest 116 has been viewed. For example, a user who has not previously seen a video 110 may not know that he wants to add a particular scene to the playlist 114 until that scene has been played.

During playback of the video 110, just after the segment of interest has finished playing, the user inputs an indication that the end of the segment of interest 116 has been reached. This user input is provided to the ending point detection component 432, which determines an ending frame 434 for the segment of interest. The ending frame 434 for the segment of interest is typically the current frame when the user input is received.

The user input is also provided to a video strip generation component 436. The video strip generation component 436 generates instructions for displaying a navigation video strip.

The navigation video strip includes several frames taken from the video 110. Typically, the frames in the navigation video strip are taken from the portion of the video 110 that was most recently displayed. The instructions generated by the video strip generation component 436 are provided to a video strip display component 438, which displays the navigation video strip on the display device 106. Various approaches for generating and displaying a navigation video strip are disclosed in co-pending U.S. patent Application entitled “Systems and Methods for Enhanced Navigation of Streaming Video,” which is assigned to the assignee of the present invention and which is hereby incorporated by reference in its entirety.

The user views the navigation video strip on the display device 106 and selects a video frame that corresponds to the beginning of the segment of interest 116. The user-selected video frame is provided to the beginning detection component 428, which determines the starting frame 430 for the segment of interest 116. The user may use the navigation video strip to readjust (change/edit) the beginning and end points of the video segment. One or more of the components 432, 434, 436, 428, and 430 may reside on the client 102 and/or the server 104.

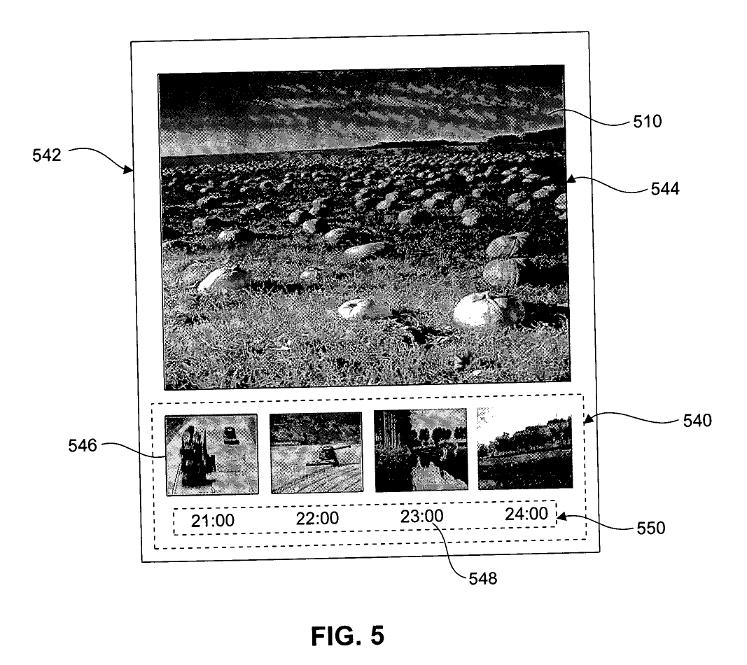

FIG. 5 illustrates a video 510 and a navigation video strip 540 being displayed on the display screen 542 of the display device 106. The video 510 is shown in a primary viewing area 544 of the display screen 542. The navigation video strip 540 is positioned beneath the primary viewing area 544. Of course, in other embodiments the navigation video strip 540 may be positioned in other locations relative to the primary viewing area 544.

The navigation video strip 540 includes several video frames 546 taken from the video 510. Each video frame 546 is scaled to fit within an area that is significantly smaller than the primary viewing area 544. Thus, relatively small “thumbnail” images are displayed for each of the frames 546 in the video strip 540. Each video frame 546 is associated with a timestamp 548 that indicates the temporal location of that video frame 546 within the video 510. The timestamp 548 of each video frame 546 is displayed in a timeline 550 within the navigation video strip 540.

In typical embodiments, when the navigation video strip 540 is not displayed, the video 510 occupies substantially all of the display screen 542. Thus, the primary viewing area 544 is reduced in size to accommodate the video strip 540. The video 510 may be scaled or clipped to fit within the smaller primary viewing area 544. Alternatively, the video strip 540 may be displayed by alpha blending it with the video 510. This would allow the video 510 to be displayed at the same time as the video strip 540 without clipping or scaling the video 510.

As discussed previously, the frames 546 shown in the video strip 540 are typically taken from the portion of the video 510 that was most recently displayed. In the illustrated embodiment, the video frames 546 are arranged sequentially in time from left to right. In addition, the video frames 546 are uniformly spaced, i.e., the amount of time separating adjacent video frames 546 is approximately the same. In the example shown in FIG. 5, the video frame 546 farthest to the right is offset by N minutes from end of the segment of interest 116, the second video frame 546 from the right is offset by 2N minutes, the third video frame 546 from the right is offset by 3N minutes, and so forth. Of course, in alternative embodiments, the video frames 546 may be non-uniformly spaced and/or arranged non-sequentially.

In some embodiments, the video 510 may be compressed, and the video frames 546 shown in the video strip 540 may include only intra-coded frames (hereinafter, “I-frames”). This may be advantageous because I-frames are typically included in the coded video 510 at a regular interval. Also, an I-frame is likely to appear in the video 510 at a scene change location, which is likely to correspond to the start of the segment of interest 116.

The beginning of the segment of interest 116 may not be visible on the display screen 542 when the video strip 540 is initially displayed. In that situation, the user may be permitted to interact with the video strip 540 in order to change the video frames 546 which are displayed in the video strip 540. For example, if the beginning of the segment of interest 116 occurs before (or after) any of the video frames 546 that are displayed on the display screen 542, the user may be permitted to view video frames 546 from an earlier (or later) portion of the video 510. This may be accomplished by providing means for the user to scroll through the video strip 540 (e.g., using LEFT/RIGHT buttons on a remote control, a scrollbar that may be moved with a mouse, etc.). If the beginning of the segment of interest 116 occurs between two video frames 546 in the video strip 540, the user may be allowed to change the time interval between adjacent frames 546 in the video strip 540. Various approaches for supporting user interaction with the video strip 540 are described in the “Systems and Methods for Enhanced Navigation of Streaming Video” application referenced above.

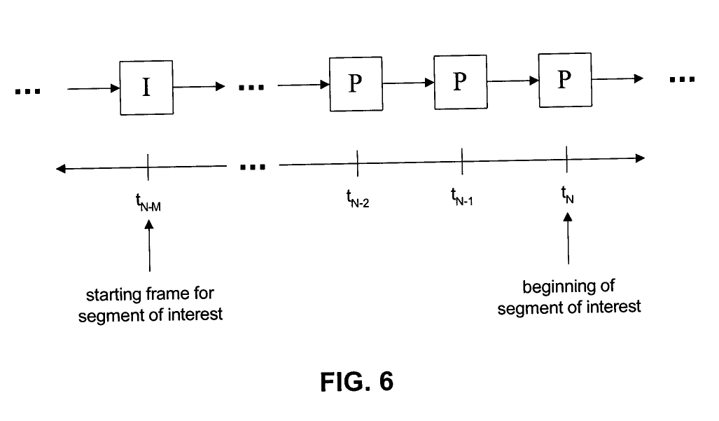

FIG. 6 illustrates an exemplary way in which a beginning detection component 328 may determine a starting frame 330 for a segment of interest 116. Successive video frames 546 in a compressed video 110 are shown. The timestamps 548 associated with the video frames 546 are also shown. In the illustrated video 110, an intra-coded (I-frame) is followed by several predictive-coded frames (hereinafter, “P-frames”).

The beginning of the segment of interest 116, as designated by the user, and the starting frame 330 for the segment of interest 116 may not be the same. This is because the frame 546 corresponding to the beginning of the segment of interest 116 may be a P-frame. In the example shown in FIG. 6, the beginning of the segment of interest 116 occurs at frame t_{N}, which is a P-frame.

The beginning detection component 328 may determine the starting frame 330 to be the last I-frame that was played back relative to the beginning of the segment of interest 116. In the example shown in FIG. 6, the last I-frame before the beginning of the segment of interest 116 is frame t_{N-M}. Thus, even though the user indicated that the segment of interest 116 starts at frame t_{N}, the beginning detection component 328 determines the starting frame 330 for the segment of interest 116 to be frame t_{N-M}.

In some embodiments, however, the client 102 may not have the capability to determine when the last I-frame occurred. In such embodiments, the beginning detection component 328 may record the starting frame 330 as the beginning of the segment of interest 116, regardless of whether or not this results in the starting frame 330 being a P-frame. If the starting frame 330 is a P-frame, and if the video segment 116 is retrieved from a server 104 during playback, the server 104 may be relied on to determine the last I-frame relative to the starting frame 330. The video segment 116 transmitted by the server 104 to the client 102 may then begin with the earlier I-frame.

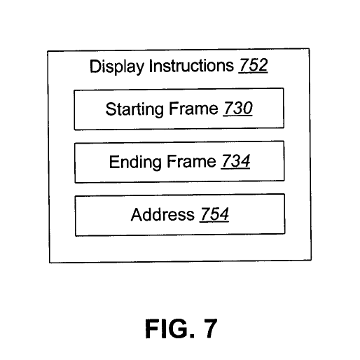

As discussed previously, once the user has selected a segment of interest 116 to be added to a playlist 114, the playlist organization component 224 adds the video segments 116 that have been designated by the user to the appropriate playlist 214. Typically, adding a video segment 116 to a playlist 214 involves generating instructions for displaying the video segment 116, and adding the display instructions to the playlist 214. FIG. 7 is a block diagram illustrating an embodiment of display instructions 752 that may be generated by the playlist organization component 224.

The display instructions 752 may include the starting frame 730 for the video segment 116 and the ending frame 734 for the video segment 116, as determined by the beginning detection component 328 and the ending detection component 332, respectively. The display instructions 752 typically also include the address 754 of the source from which the video segment 116 may be retrieved during playback. The starting frame 730 and the ending frame 734 may be in the form of a time code, a frame number, or the like.

In some embodiments, the playlist 114 may be written in Synchronized Multimedia Integration Language (SMIL). The display instructions 752 for a single video segment may be contained within a single SML video element. The starting frame 730 may take the form of a clipBegin attribute within the SML video element. The ending frame 734 may take the form of a clipEnd attribute within the SMIL video element. The source address 754 may take the form of a src attribute within the SMIL video element.

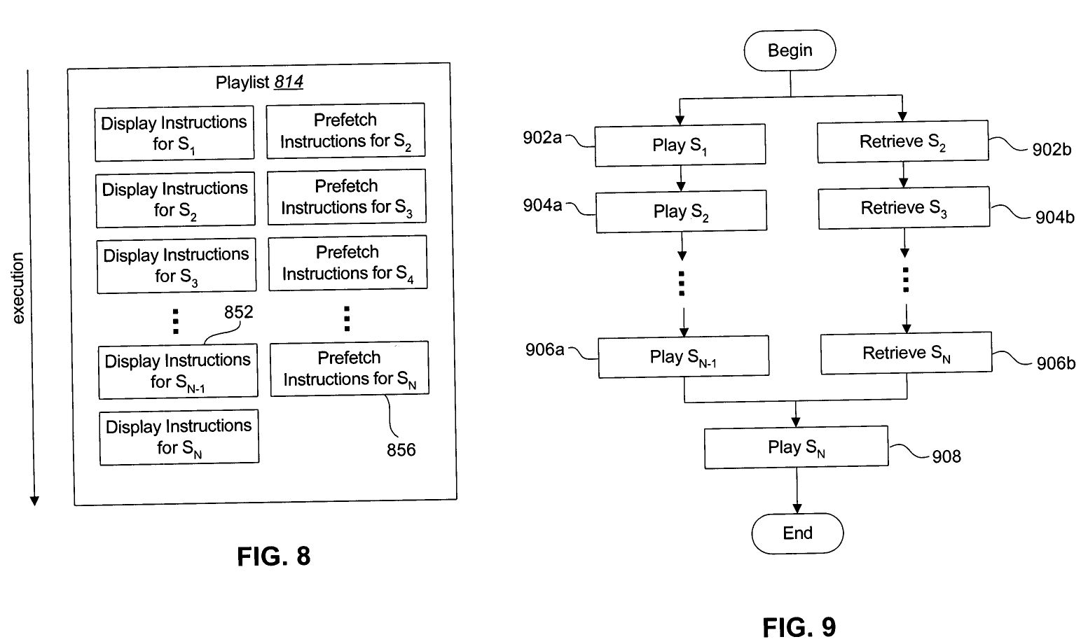

FIG. 8 is a block diagram illustrating an embodiment of a playlist 814. The playlist 814 includes a plurality of display instructions 852. Each of the various display instructions 852 corresponds to a segment of interest 116 designated by the user.

The display instructions 852 are arranged in a particular order. In the illustrated embodiment, the display instructions 852 are executed sequentially; therefore, the various video segments 116 are played back in the same order in which the display instructions 852 are arranged. For example, in the exemplary playlist 814, segment S₁ is played first, followed by segment S₂, then segment S₃, and so on.

There may be a delay between the time that a particular segment 116 finishes playing and the time that the next segment 116 in the playlist 114 begins playing. This may be the case, for example, if the segments 116 are played back via streaming.

To substantially reduce (or even eliminate) this delay, the playlist 114 may include prefetch instructions 856 for some or all of the video segments in the playlist 114. The prefetch instructions 856 are instructions to retrieve a particular segment of interest 116 (or, at least a portion of the segment of interest 116) before that segment of interest 116 is scheduled to be played. The prefetch instructions 856 may be added to the playlist 114 by the playlist organization component 224.

As shown in FIG. 8, the prefetch instructions 856 for a particular video segment may be positioned in the playlist 814 so that they are executed in parallel with the display instructions 852 for the previous video segment 116 in the playlist 814. In other words, the prefetch instructions 856 for video segment S_{N} may be executed in parallel with the display instructions 852 for video segment S_{N-1}.

As discussed previously, in some embodiments, the playlist 814 may be written in SMIL. The prefetch instructions 856 for a video segment 116 may be contained within a SMIL prefetch element. The prefetch instructions 856 for video segment SN and the display instructions 852 for video segment S_{N-1} may be contained within the same SMIL par element.

FIG. 9 is a flow diagram illustrating an exemplary way in which the playlist display component 226 may play back the video segments 116 in the playlist 814 of FIG. 8. As shown, segment S₁ is played 902a in parallel with some or all of segment S₂ being retrieved 902b. Segment S₂ is played 904a in parallel with some or all of segment S₃ being retrieved 904b. This pattern continues until segment S_{N-1} is played 906a in parallel with some or all of segment S_{N} being retrieved 906b. Playback of the playlist 814 ends after segment S_{N} is played 908.

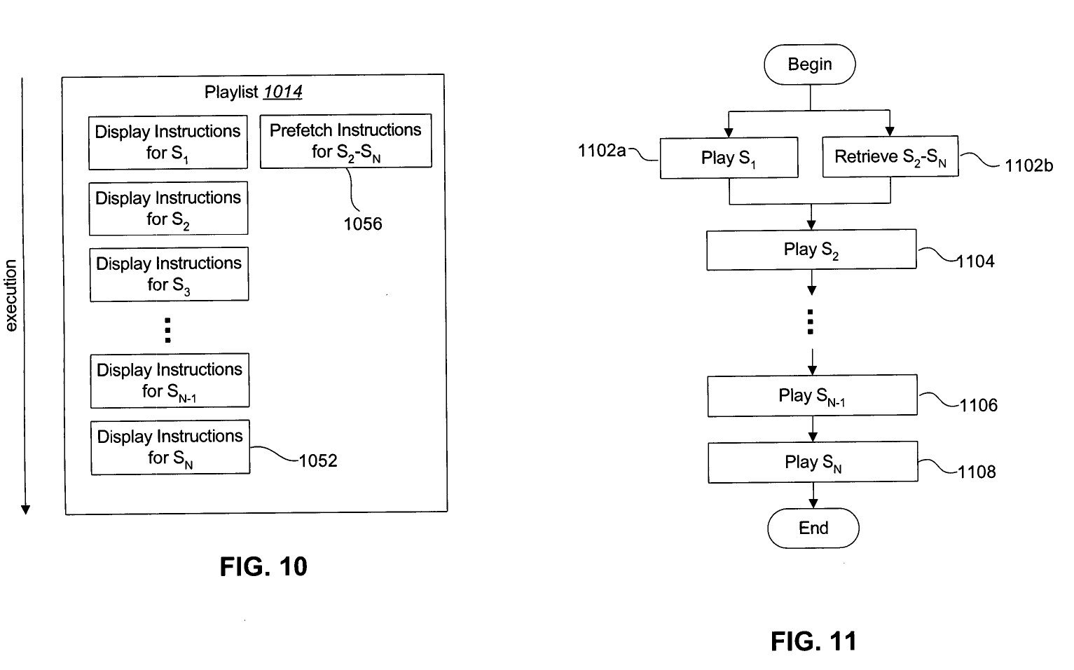

FIG. 10 is a block diagram illustrating an alternative embodiment of a playlist 1014. The playlist 1014 includes display instructions 1052 for video segments S₁-S_{N}. The playlist 1014 also includes prefetch instructions 1056 for video segments S₂-S_{N}. The prefetch instructions 1056 for video segments S₂-S_{N} are positioned in the playlist 1014 so that they are executed in parallel with the display instructions 1052 for the segment S₁. The display instructions 1052 for video segments S₂-S_{N} are positioned so that they are executed sequentially.

FIG. 11 is a flow diagram illustrating an exemplary way in which the playlist display component 226 may play back the video segments 116 in the playlist 1014 of FIG. 10. As shown, segment S₁ is played 1102a in parallel with some or all of segments S₂-S_{N} being retrieved 1102b. Segment S₂ is then played 1104, followed by segment S₃ (not shown), and so on, until segment S_{N-1} is played 1106. Playback of the playlist 1014 ends after segment S_{N} is played 1108.

In an alternative embodiment, the prefetch instructions for future video segments may occur in parallel with any of the past and present display instructions. In some embodiments, some of the future video segments may not be prefetched. In some embodiments, the playlist 814 or 1014 may be reordered to create a different playlist. The prefetch instructions occurring in parallel with the display instructions may then be determined based on the new display order of the segments.

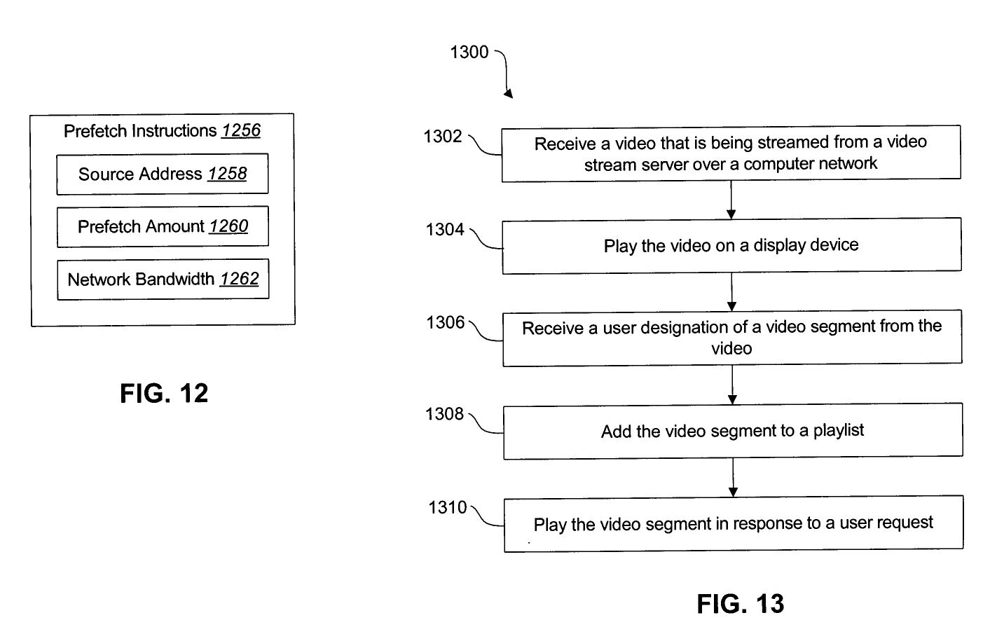

FIG. 12 is a block diagram illustrating an embodiment of the prefetch instructions 1256 for a particular video segment 116. The prefetch instructions 1256 typically include the address 1258 of the source from which the video segment may be retrieved during playback. The prefetch instructions 1256 may also indicate the amount 1260 to be prefetched, i.e., how much of the video 110 is prefetched. The prefetch instructions 1256 may also indicate the amount of network bandwidth 1262 the client 102 allocates when doing the prefetch.

As mentioned previously, in some embodiments the playlist 114 may be written in SMIL, and the prefetch instructions 1256 for a video segment 116 may be contained within a SMIL prefetch element. The source address 1258 may take the form of a src attribute within the SMIL prefetch element. The amount 1260 to be prefetched may take the form of a mediaSize attribute within the SMIL prefetch element. The amount of network bandwidth 1262 may take the form of a bandwidth attribute within the SMIL prefetch element.

The mediaSize attribute may be created using a number of approaches. For example, the client 102 may use the value of the pre-roll buffering delay corresponding to the beginning of the segment as the value for the mediaSize attribute. Alternatively, the client 102 may send a GET_PARAMETER request to the RTSP server 104 with the Normal Play Time (npt) value equal to the beginning of the segment and will receive back a value to set for the mediaSize attribute. An example RTSP interaction using this approach is shown below. The interaction begins when the client 102 sends the following message to the server 104:
GET_PARAMETER rtsp://homeserver.com/video/matrix.rm RTSP/1.0
CSeq: 84
Content-Type: text/parameters
Session: 4587
Content-Length: 18
MediaSize;npt=95

The server 104 then sends the following message to the client 102:
RTSP/1.0 200 OK
CSeq: 84
Content-Length: 48
Content-Type: text/parameters
MediaSize: 105834

Alternatively, the client 102 may send a dummy RTSP PLAY request or a PLAY request with very small “dur” attribute (in SMIL) starting at the npt of the beginning of the segment. The client 102 may then extract the pre-roll buffer delay value from the streaming media sent by the server 104. The streaming media will not be played back. The client 102 may alternatively choose to measure the time-delay required to buffer the data equal to the pre-roll buffer size, or the size of the first media frame if no information about the pre-roll buffer size is available.

The bandwidth attribute may be created using a number of approaches. For example, if information about the previous video segment (in the video playlist) bitrate and client's nominal bandwidth is available, the bandwidth attribute may be set to the difference between the nominal client bandwidth and the previous video segment bitrate. If no such information is available the bandwidth attribute may be set to some small percentage value (e.g. 10%).

Exemplary methods which may be performed by the client 102 (e.g., the playlist display component 226) and the server 104 during playback of the video playlist 114 will now be described. In these examples, the symbol Si will be used to refer to the ith video segment in the video playlist 114 with i=1, . . . ,N. The symbols Sti and Eti will be used to represent beginning and ending timecode values on the clip timeline for the video segment Si. These will be the clipBegin and clipEnd attributes in SMIL for the video segment. The symbol Bi bytes will be used to refer to the value (bytes-value) of the amount of data to be prefetched (which is the mediaSize attribute for the prefetch element if using SMIL) corresponding to the video segment Si. The symbol Ri will be used to refer to the value (bitrate-value) of the bandwidth to be used for prefetching (which will be the bandwidth attribute for the prefetch element if using SMIL) for the video segment Si. The symbol Cri will be used to refer to the actual bit-rate (in bits per second) of the video segment Si. Thus knowing the value of Bi and Cri for video segment Si, a new parameter pre-roll buffer delay=Di=(8*Bi)/Cri can be defined.

The first exemplary method that will be described may be used with the playlist 814 shown in FIG. 8 and described in connection therewith. The method begins when the client 102 sends an RTSP PLAY request to the server 104 with the npt=St1-Et1 for the video segment S1. Video data corresponding to segment S1 is then streamed to the client 102. Video playback is started when sufficient data is buffered at the client based on the pre-roll buffer size parameter for the video segment S1. In parallel, the client 102 sends an RTSP PLAY request to the server 104 with the npt=St2-Et2 for the video segment S2. After B2 bytes of the payload data for the video segment S2 are obtained and buffered, a RTSP PAUSE request is sent for the video segment S2. No video is played back for the video segment S2.

After the video segment S1 finishes playback, the client 102 sends an RTSP PLAY request to the server 104 for the video segment S2 as before with the npt=(St2+Ts2)-Et2, where Ts2 is the timestamp of the last buffered frame for video segment S2. But the video playback for S2 is started immediately using the already buffered data for S2. Since the value of B2 is set during the creation of the playlist 814 to equal to the pre-roll buffer size for S2, so this results in no underflow and the video playback will continue uninterrupted until the video segment S2 finishes at its scheduled time. In parallel with this step, the client 102 sends an RTSP PLAY request to the server 104 for the video segment S3 with npt=St3−Et3 and the payload data equal to size B3 is buffered. As before a RTSP PAUSE request for S3 is sent when the desired buffer size is filled up. No video is played back for the video segment S3. The above steps are repeated for each of the next video segments to be played back and for the prefetch elements in parallel.

Another exemplary method will now be described. This method may also be used with the playlist 814 shown in FIG. 8 and described in connection therewith. The client 102 sends an RTSP PLAY request to the server 104 with the npt=St1−Et1 for the video segment S₁. The video playback is started when sufficient data is buffered based on the pre-roll buffer size parameter for the video segment S1. The client 102 sends an RTSP PLAY request to the server 104 with the npt=St2−Et2 for the video segment S2 at npt time Et1−D1 with respect to the video segment S1 timeline. The video playback is not started for video segment S2. Instead, the received data is buffered. This will result in all the video payload data equal to the pre-roll buffer size B2 for S2 to be already buffered at time Et1, so that the video playback for S2 can start at Et1. The above steps are repeated for each of the next video segments to be played back and for the prefetch elements in parallel.

Another exemplary method will now be described. This method may also be used with the playlist 1014 shown in FIG. 10 and described in connection therewith. The client 102 sends an RTSP PLAY request to the server with the npt=St1−Et1 for the video segment S1. The video playback is started when sufficient data is buffered based on the pre-roll buffer size parameter for the video segment S1. Also in parallel (N-1) RTSP PLAY requests are sent with the npt=St1−Eti for each of the video segments S1, with i=2, . . . N. After Bi bytes of the payload data for the video segment Si are obtained and buffered, a RTSP PAUSE request is sent for the video segment Si, with i=2, . . . N. No video is played back for any of the video segments Si. The RTSP PLAY request is sent for the video segment Si at its scheduled playback time with the npt=(Sti+Tsi)−Eti, where Tsi is the timestamp of the last buffered frame for video segment Si. But the video playback for Si is started immediately using the already buffered data. The value of Bi is set during the creation of the video playlist 114 to equal to the pre-roll buffer size for Si. Accordingly, this will result in no underflow and the video playback will continue uninterrupted till the video segment Si finishes at its scheduled time.

FIG. 13 is a flow diagram illustrating an embodiment of a method 1300 that may be performed by the client 102 in the operating environment shown in FIG. 1. The method 1300 begins when the client 102 receives 1302 a video 110 that is being streamed from a server 104 over a computer network 108 and plays 1304 the video 110 on the display device 106.

The client 102 receives 1306 a user designation of a video segment 116 from the video 110. In some embodiments, the client 102 may be configured so that a user can add a segment of interest 116 to a playlist 114 while the segment of interest 116 is being viewed on the display device 106. Alternatively, the client 102 may be configured so that a user can add a segment of interest 116 to a playlist 114 after the segment of interest 116 has been viewed.

The client 102 adds 1308 the video segment 116 to a playlist 114. In some embodiments, the client 102 may send the user input to add a segment of interest to the playlist to the server 104 and the server may add the segment to the playlist. The playlist 114 may be stored on the server 104 in this case. Typically, adding 1308 a video segment 116 to a playlist 114 involves generating instructions for displaying the video segment 116, and adding the display instructions to the playlist 114.

The client 102 plays 1310 the video segment 116 in the playlist 114 in response to a user request. If the playlist 114 is stored on the server, the client 102 may partially or completely retrieve the playlist 114 from the server 104. The playlist 114 may include several video segments 116, and a user may input a request to play some or all of the video segments 116 in the playlist 114. Playback of a particular video segment 116 in a playlist 114 may involve retrieving the video segment 116 from a server 104. The video segment 116 may be streamed from the server 104 to the client 102 for playback. Alternatively, the video segment 116 may be downloaded to and stored locally on the client 202 during creation of the playlist 114. Then the client 102 may retrieve the video segment 116 from a local storage device for playback.

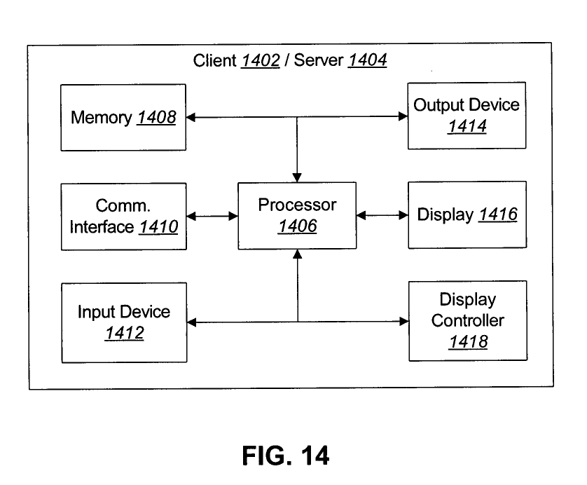

FIG. 14 is a block diagram illustrating the components typically utilized in a client 1402 and/or a server 1404 used with embodiments herein. The illustrated components may be logical or physical and may be implemented using any suitable combination of hardware, software, and/or firmware. In addition, the different components may be located within the same physical structure or in separate housings or structures.

The computer system shown in FIG. 14 includes a processor 1406 and memory 1408. The processor 1406 controls the operation of the computer system and may be embodied as a microprocessor, a microcontroller, a digital signal processor (DSP) or other device known in the art. The processor 1406 typically performs logical and arithmetic operations based on program instructions stored within the memory 1408.

As used herein, the term “memory” 1408 is broadly defined as any electronic component capable of storing electronic information, and may be embodied as read only memory (ROM), random access memory (RAM), magnetic disk storage media, optical storage media, flash memory devices in RAM, on-board memory included with the processor 1406, EPROM memory, EEPROM memory, registers, etc. Whatever form it takes, the memory 1408 typically stores program instructions and other types of data. The program instructions may be executed by the processor 1406 to implement some or all of the methods disclosed herein.

The computer system typically also includes one or more communication interfaces 1410 for communicating with other electronic devices. The communication interfaces 1410 may be based on wired communication technology, wireless communication technology, or both. Examples of different types of communication interfaces 1410 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system typically also includes one or more input devices 1412 and one or more output devices 1414. Examples of different kinds of input devices 1412 include a keyboard, mouse, microphone, remote control device, button, joystick, trackball, touchpad, lightpen, etc. Examples of different kinds of output devices 1414 include a speaker, printer, etc. One specific type of output device which is typically included in a computer system is a display device 1416. Display devices 1416 used with embodiments disclosed herein may utilize any suitable image projection technology, such as a cathode ray tube (CRT), liquid crystal display (LCD), light-emitting diode (LED), gas plasma, electroluminescence, or the like. A display controller 1418 may also be provided, for converting data stored in the memory 1408 into text, graphics, and/or moving images (as appropriate) shown on the display device 1416.

Of course, FIG. 14 illustrates only one possible configuration of a computer system. Those skilled in the art will recognize that various other architectures and components may be utilized. In addition, various standard components are not illustrated in order to avoid obscuring aspects of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

1. In a client, a method for providing playlist functionality, comprising:
receiving a video;
displaying the video on a display device;
receiving a user designation of a video segment from the video; and
adding the video segment to a playlist.

2. The method of claim 1, wherein the video is streamed from a server.

3. The method of claim 1, wherein the video is stored on the client.

4. The method of claim 1, wherein the video is available remotely via file sharing.

5. The method of claim 1, wherein the playlist is stored on the client.

6. The method of claim 1, wherein the playlist is stored on the server.

7. The method of claim 1, further comprising receiving user input to determine whether the video segment is added to a new playlist or to an existing playlist.

8. The method of claim 1, wherein adding the video segment to the playlist comprises:
generating display instructions for displaying the video segment; and
adding the display instructions to the playlist.

9. The method of claim 1, wherein the playlist is created using Synchronized Multimedia Integration Language (SMIL).

10. The method of claim 1, wherein receiving the user designation of the video segment comprises:
receiving a first user indication of a beginning portion of the video segment, wherein the first user indication is received when the beginning portion is played on the display device; and
receiving a second user indication of an ending portion of the video segment, wherein the second user indication is received when the ending portion is played on the display device.

11. The method of claim 1, wherein receiving the user designation of the video segment comprises:
receiving a first user indication of a beginning portion of the video segment, wherein the first user indication is received after the beginning portion is played on the display device; and
receiving a second user indication of an ending portion of the video segment.

12. The method of claim 11, wherein receiving the first user indication comprises:
displaying a navigation video strip on the display device, wherein the navigation video strip comprises a plurality of frames from the video; and
receiving a user selection of a frame from the plurality of frames, wherein the frame substantially corresponds to the beginning portion of the video segment.

13. The method of claim 12, wherein receiving the first user indication further comprises supporting user interaction with the navigation video strip.

14. The method of claim 1, further comprising playing the video segment in response to a user request.

15. The method of claim 14, wherein the video segment is played using Real Time Streaming Protocol (RTSP).

16. The method of claim 14, wherein playing the video segment comprises retrieving at least a portion of the video segment in parallel with playing a previous video segment in the playlist.

17. The method of claim 16, wherein the amount of the video segment to be retrieved in parallel is determined by the client while creating the playlist.

18. The method of claim 16, wherein the amount of the video segment to be retrieved in parallel is determined by the client after requesting information from the server and while creating the playlist.

19. The method of claim 16, wherein information about the amount of the video segment to be retrieved in parallel is stored in the playlist.

20. A client that is configured to provide playlist functionality, comprising:
a stream reception component configured to receive a video;
a stream display component configured to display the video on a display device;
a segment designation component configured to receive a user designation of a video segment from the video; and
a playlist management component configured to add the video segment to a playlist.

21. The client of claim 20, wherein the video is streamed from a server.

22. The client of claim 20, wherein the video is stored on the client.

23. The client of claim 20, wherein the video is available remotely via file sharing.

24. The client of claim 20, wherein the playlist is stored on the client.

25. The client of claim 20, wherein the playlist is stored on the server.

26. The client of claim 20, wherein the playlist management component is further configured to receive user input to determine whether the video segment is added to a new playlist or to an existing playlist.

27. The client of claim 20, wherein the playlist is created using Synchronized Multimedia Integration Language (SMIL).

28. The client of claim 20, wherein the segment designation component comprises:
a beginning detection component configured to receive a first user indication of a beginning portion of the video segment, wherein the first user indication is received at substantially the same time as the beginning portion is played on the display device; and
an ending detection component configured to receive a second user indication of an ending portion of the video segment, wherein the second user indication is received at substantially the same time as the ending portion is played on the display device.

29. The client of claim 20, wherein the segment designation component comprises:
a beginning detection component configured to receive a first user indication of a beginning portion of the video segment, wherein the first user indication is received after the beginning portion is played on the display device; and
an ending detection component configured to receive a second user indication of an ending portion of the video segment.

30. The client of claim 29, further comprising a video strip display component configured to display a navigation video strip on the display device, wherein the navigation video strip comprises a plurality of frames from the video, and wherein receiving the first user indication comprises receiving a user selection of a frame from the plurality of frames.

31. A set of executable instructions for implementing a method for providing playlist functionality, the method comprising:
receiving a video;
displaying the video on a display device;
receiving a user designation of a video segment from the video; and
adding the video segment to a playlist.

32. The set of executable instructions of claim 31, wherein the playlist is created using Synchronized Multimedia Integration Language (SMIL).

33. The set of executable instructions of claim 31, wherein adding the video segment to the playlist comprises:
generating display instructions for displaying the video segment; and
adding the display instructions to the playlist.

34. The set of executable instructions of claim 31, wherein the video is streamed from a server.

35. The set of executable instructions of claim 31, wherein the video is stored on the client.

36. The set of executable instructions of claim 31, wherein the video is available remotely via file sharing.

37. The set of executable instructions of claim 31, wherein the playlist is stored on the client.

38. The set of executable instructions of claim 31, wherein the playlist is stored on the server.

39. The set of executable instructions of claim 31, wherein the method further comprises receiving user input to determine whether the video segment is added to a new playlist or to an existing playlist.

40. The set of executable instructions of claim 31, wherein receiving the user designation of the video segment comprises:
receiving a first user indication of a beginning portion of the video segment, wherein the first user indication is received at substantially the same time as the beginning portion is played on the display device; and
receiving a second user indication of an ending portion of the video segment, wherein the second user indication is received at substantially the same time as the ending portion is played on the display device.

41. The set of executable instructions of claim 31, wherein receiving the user designation of the video segment comprises:
receiving a first user indication of a beginning portion of the video segment, wherein the first user indication is received after the beginning portion is played on the display device; and
receiving a second user indication of an ending portion of the video segment.

42. The set of executable instructions of claim 31, wherein the method further comprises playing the video segment in response to a user request.

43. The set of executable instructions of claim 42, wherein the video segment is played using Real Time Streaming Protocol (RTSP).

44. The set of executable instructions of claim 42, wherein playing the video segment comprises retrieving at least a portion of the video segment in parallel with playing a previous video segment in the playlist.

45. A set of executable instructions for implementing a method for providing playlist functionality, the method comprising:
receiving a user designation of a video segment from a video;
generating display instructions for displaying the video segment; and
adding the display instructions to a playlist.

46. The set of executable instructions of claim 45, wherein the video is streamed from a server.

47. The set of executable instructions of claim 45, wherein the video is stored on the client.

48. The set of executable instructions of claim 45, wherein the video is available remotely via file sharing.

49. The set of executable instructions of claim 45, wherein the playlist is stored on the client.

50. The set of executable instructions of claim 45, wherein the playlist is stored on the server.

51. The set of executable instructions of claim 45, wherein the method further comprises receiving user input to determine whether the video segment is added to a new playlist or to an existing playlist.

52. The method of claim 45, wherein the playlist is created using Synchronized Multimedia Integration Language (SMIL).

53. A set of executable instructions for implementing a method for providing playlist functionality, the method comprising:
receiving a user designation of a media segment from a media file;
generating instructions for producing a user-perceptible form of the media segment; and
adding the instructions to a playlist.

54. The set of executable instructions of claim 53, wherein the video is streamed from a server.

55. The set of executable instructions of claim 53, wherein the video is stored on the client.

56. The set of executable instructions of claim 53, wherein the video is available remotely via file sharing.

57. The set of executable instructions of claim 53, wherein the playlist is stored on the client.

58. The set of executable instructions of claim 53, wherein the playlist is stored on the server.

59. The set of executable instructions of claim 53, wherein the method further comprises receiving user input to determine whether the video segment is added to a new playlist or to an existing playlist.

60. The set of executable instructions of claim 53, wherein the playlist is created using Synchronized Multimedia Integration Language (SMIL).
